(19) United States
(12) Patent Application Publication
(10) Pub. No.: US 2013/0131939 A1
(43) Pub. Date: May 23, 2013

(54) CONTROL TECHNIQUE FOR VEHICLE WITH SHIFT BY WIRE SYSTEM

(71) Applicants: Jin Sook Lee, Hwaseong (KR); Kyung Ha Kim, Yongin (KR); Min Sung Kim, Seoul (KR); Yeon Ho Kim, Suwon (KR)

(72) Inventors: Jin Sook Lee, Hwaseong (KR); Kyung Ha Kim, Yongin (KR); Min Sung Kim, Seoul (KR); Yeon Ho Kim, Suwon (KR)

(73) Assignee: HYUNDAI MOTOR COMPANY, Seoul (KR)

(21) Appl. No.: 13/523,009

(22) Filed: Jun. 14, 2012

(30) Foreign Application Priority Data
Nov. 23, 2011 (KR) 10-2011-0122886

(51) Int. Cl. B60W 30/00; B60W 10/18; G06F 7/00; B60W 10/10

(52) U.S. Cl. 701/53; 701/59

(57) ABSTRACT

Disclosed is a control technique that prevents a transmission automatically decelerates a vehicle when an ignition in the vehicle is turned off accidentally while the vehicle is moving and waits until the vehicle is completely stopped to automatically shift and lock the transmission of the vehicle in Park electronically.

### CROSS-REFERENCE TO RELATED APPLICATION

This application claims under 35 U.S.C. §119(a) the benefit of Korean Patent Application No. 10-2011-0122886 filed on Nov. 23, 2011, the entire contents of which are incorporated herein by reference.

### BACKGROUND

(a) Technical Field

The present invention relates to a control method for a vehicle provided with a Shift By Wire system (SBW). More particularly, the present invention relates to a control system and method in accordance with a driver's manipulation of a gear shift into a Park (P) position.

(b) Background Art

Generally, SBW systems convert a driver's manipulation of a gear shift to an electric signal and sends the signal to the transmission of the vehicle so that the transmission can be controlled without transmission of a mechanical displacement by a cable like in conventional transmissions. That is, in a vehicle provided with the SBW system, when a driver selects positions P-R-N-D using a gear shifting device, only an electric signal is transmitted to the transmission so that a gear shift manipulation is implemented, and when a driver selects a P position to park a vehicle, a motor mounted in the transmission is driven to operate a parking sprag to control a gear inside the transmission.

For example, in FIG. 1 is a schematic view illustrating a conventional method for processing gear shifting when a driver selects the Park provided with a SBW system. In the conventional control method when a driver turns off the ignition in any position besides the Park position, the SBW system automatically switches to Park.

The conventional control method described above ensures that the vehicle is securely parked by setting the gear to the P position automatically (S502) when a driver turns off the ignition (S500) after parking a vehicle normally, and it prevents the vehicle from suddenly accelerating when vehicle is restarted. On the contrary, when the ignition is turned off unintentionally or during an emergency, the gears in the transmission are shifted into park and thus may cause damaged to the transmission or at the very least cause the vehicle to stop suddenly which in some situations could cause an accident.

The articles described as the background art in the forgoing only intend to help the reader further understand the background art in relation to the present invention, and thus those examples are not to be understood as acknowledgement of prior art which is known to a person having an ordinary skill in the art.

### SUMMARY OF THE DISCLOSURE

The present invention provides a control method and system a transmission in a vehicle to be safely shifted into Park while at the same time preventing the vehicle from coming to a sudden stop or causing damage to various parts in the transmission even when a driver turns off the ignition in both intentional and unintentional situations. Furthermore, the illustrative embodiment of the present invention also prevents the vehicle come suddenly accelerating when the vehicle is turned back on.

To achieve the above objectives, the control technique for a vehicle with a SBW system installed therein in accordance with the illustrative embodiment of the present invention includes a control unit configured to determine whether a current velocity of the vehicle is zero (0) when the ignition of a vehicle is turned off; maintain the previous gear position before turning off the ignition when the velocity is not equal to zero; decelerate the velocity of the vehicle via a braking system installed in the vehicle while maintaining the last gear position; and shift the vehicle into park automatically and lock the vehicle in park once the vehicle comes to a stop.

In addition, the control unit may also be configured to determine in advance the current velocity of the vehicle (S10) before shifting the transmission into Park once a driver turns off the ignition of a vehicle provided with a SBW system and control whether the vehicle is instantly shifted into park or shifted into park after the vehicle has come to a stop based on data related to the current velocity of the vehicle.

### BRIEF DESCRIPTION OF THE DRAWINGS

The above and other features of the present invention will now be described in detail with reference to certain exemplary embodiments thereof illustrated the accompanying drawings which are given herein below by way of illustration only, and thus are not limitative of the present invention, and wherein:

FIG. 1 is a flow chart showing a control method of a vehicle provided with a SBW system according to a prior art; and

FIG. 2 is a flow chart showing a control method of a vehicle provided with a SBW system in accordance with an exemplary embodiment of the present invention.

FIG. 3 is a schematic diagram illustrating a control system of the exemplary embodiment of the present invention.

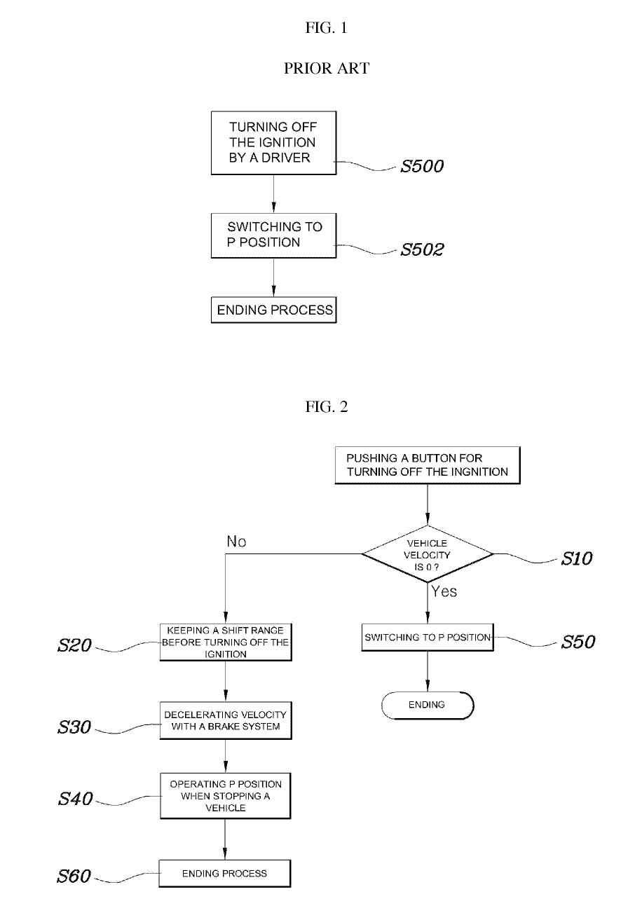

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below.

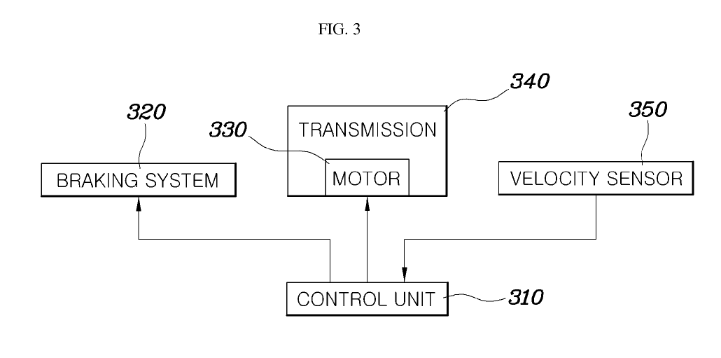

Referring to FIG. 2, a control method for the vehicle provided with a SBW system in accordance with an exemplary embodiment of the present invention. FIG. 3 illustrates a schematic diagram of the control system for implementing the exemplary embodiment of the present invention. As shown in FIG. 3, the control unit 310 is configured to send and receive data/signals to and from a braking system 320 and a motor 330 operably connected to a transmission 340 configured to electronically control gear shifting in the transmission 340. The control 310 is also configured to receive data from a velocity sensor 350 (e.g., speedometer) installed in the vehicle and configured to detect the current speed/velocity of the vehicle.

More specifically, the control method may be executed by a controller 310 that can be programmed with control logic that in response to sensing that a vehicle ignition has been turned off, determines whether a current velocity of the vehicle is zero (0) (S10, maintains the transmission in the same gear position that the vehicle was in before the ignition was turned off when the current velocity of the vehicle is not-zero (S20, decelerates the velocity of the vehicle via applying a braking system while maintaining the same gear position (S20) (S30), and shifts and locks the transmission into Park once the vehicle has come to a stop or at least almost a complete stop (S40).

That is, when a driver turns off the ignition in a vehicle provided with a SBW system, the control unit 310 is triggered to determine the current velocity of the vehicle S10 before shifting the transmission into Park and then the control unit determines whether to instantly shift the vehicle transmission into Park or post pone shifting the transmission into park until after the vehicle has come to a stop based on data obtained in relation to the vehicle's current velocity. Thus, when the control unit 310 determines that the velocity of the vehicle is above the predetermined value, deceleration is performed while maintaining the transmission in positioning the same position as it was before the ignition was turned off. Conversely, when the velocity of the vehicle is below the predetermined value, the transmission is automatically shifted into Park and locked in Park for until, e.g., one or more predetermined safety conditions have been satisfied or a certain amount of time has elapsed.

By controlling the vehicle in the above manner, an unintentional sudden switching to Park while the vehicle is traveling at speeds above, e.g., zero mph, can be avoided and thus prevent damage to parts of the transmission and accidents that could be caused due to a vehicle suddenly stopping.

For reference, the predetermined value of the vehicle velocity may be set to about 0˜2 km/h/mph, which in most instances is considered a stopped state and thus is safe to shift the vehicle into Park.

By ensuring that the vehicle is not shifted into Park until after the vehicle's velocity is zero (S50) vehicle safety is greatly improved. Furthermore, since the transmission is locked in Park, when the vehicle is restarted, the vehicle is prevented from suddenly accelerating as well. Furthermore, after the control unit shifts the vehicle into park in step (S40), the brake system used in decelerating of the vehicle velocity is released to perform the process ending step (S60) for completing the vehicle control.

Advantageously, the illustrative embodiment of the present invention guarantees vehicle safety by preventing sudden stops and acceleration by shifting automatically the transmission into Park when a vehicle's ignition is turned only once the vehicle has come to a complete or almost complete stop. Furthermore, the present invention maximizes vehicle safety by automatically decelerating the vehicle until it comes to a complete stop before shifting the transmission automatically into Park, thus allowing for a smooth stop and an environment for safely shifting the vehicle into Park without causing an accident or damage to parts of the transmission.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage to devices. The computer readable recording medium can also be distributed in network coupled computer systems so that the computer readable media is stored and executed in a distributed fashion, e.g., by a telematics server or a Controller Area Network (CAN).

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

What is claimed is:

1. A control method for the vehicle installed with a Shift By Wire (SBW) system comprising:
determining, by a control unit, whether a current velocity of the vehicle is zero (0) when an ignition of a vehicle is turned off;
maintaining, by the control unit, a gear position of a transmission in place before turning off the ignition when the velocity is greater than zero;
decelerating, by the control unit, the velocity of the vehicle by applying a braking system while simultaneously maintaining the previous gear position of the transmission; and
shifting and locking, by the control unit, the transmission into Park once the velocity of the vehicle is equal to zero.

2. The control method of claim 1, further comprising shifting the transmission into Park automatically once the control unit determines that the current velocity of the vehicle is zero based on data received from a velocity sensor installed in the vehicle.

3. The control method of claim 1, further comprising releasing the brake system once the transmission is shifted into park.

4. A control method of the vehicle provided with a SBW system, comprising:
determining, by a control unit, in advance a current velocity of a vehicle before shifting a transmission into Park when a driver turns off the ignition in a vehicle provided with a SBW system; and
determining, by the control unit, whether to shift the transmission into Park instantaneously or post pone shifting the vehicle into Park until after the vehicle has come to a stop.

5. The control method of claim 4, wherein, the transmission is instantaneously shifted into Park when the control unit determines that the velocity of the vehicle is equal to or below a predetermined value and postponing shifting the transmission into Park when the current velocity of the vehicle is above the predetermined value.

6. A non-transitory computer readable medium containing program instructions executed by a processor or controller, the computer readable medium comprising:
program instructions that determine whether a current velocity of the vehicle is zero (0) when an ignition of a vehicle is turned off;
program instructions that maintain a gear position of a transmission in place before turning off the ignition when the velocity is greater than zero;
program instructions that decelerate the velocity of the vehicle by applying a braking system while simultaneously maintaining the previous gear position of the transmission; and
program instructions that shift and lock the transmission into Park once the velocity of the vehicle is equal to zero.

7. The non-transitory computer readable medium of claim 6, further comprising program instructions that shift the transmission into Park automatically once the control unit determines that the current velocity of the vehicle is zero based on data received from a velocity sensor installed in the vehicle.

8. The non-transitory computer readable medium of claim 6, further comprising program instructions that release the brake system once the transmission is shifted into park.

9. A system comprising:
a control unit configured to determine whether a current velocity of the vehicle is zero (0) when an ignition of a vehicle is turned off, maintain a gear position of a transmission in place before turning off the ignition when the velocity is greater than zero, decelerate the velocity of the vehicle by applying a braking system while simultaneously maintaining the previous gear position of the transmission, and shift and lock the transmission into Park once the velocity of the vehicle is equal to zero.

10. The system of claim 9, wherein the control unit is configured to shift the transmission into Park automatically once the control unit determines that the current velocity of the vehicle is zero based on data received from a velocity sensor installed in the vehicle.

11. The system claim 1, wherein the control unit is configured to release the brake system once the transmission is shifted into park.
